(19) United States
(12) Patent Application Publication
(10) Pub. No.: US 2011/0021695 A1
(43) Pub. Date: Jan. 27, 2011

(54) URETHANE (METH) ACRYLATE COMPOSITION AND SEAL MEMBER

(75) Inventors: Kouichi Akiyama, Tokushima-shi (JP); Norihiro Fukuta, Tokushima-shi (JP); Masanori Sukenobu, Tokushima-shi (JP); Souichirou Komiya, Tokushima-shi (JP); Hiroyuki Fujita, Tokushima-shi (JP); Kenji Horie, Tokushima-shi (JP); Takako Oyama, Komagane-shi (JP); Noriyuki Sera, Kamiina-gun (JP); Hisayoshi Makabe, Ina-shi (JP)

Correspondence Address: HOLTZ, HOLTZ, GOODMAN & CHICK PC, 220 Fifth Avenue, 16TH Floor, NEW YORK, NY, 10001-7708, US

(73) Assignees: HITACHI KASEI POLYMER CO., LTD., Tokyo (JP); NHK SPRING CO., LTD., Yokohama-shi (JP)

(21) Appl. No.: 12/893,121

(22) Filed: Sep. 29, 2010

Related U.S. Application Data
(63) Continuation of application No. PCT/JP2009/056748, filed on Mar. 31, 2009.

(30) Foreign Application Priority Data
Mar. 31, 2008 (JP) 2008-094386

(51) Int. Cl. C08L 75/04; C08G 18/73; C08G 18/76

(52) U.S. Cl. 524/590; 528/75

(57) ABSTRACT

A urethane (meth)acrylate composition includes a product of a reaction of a polyester polyol made from a polycarboxylic acid and a polyhydric alcohol, a polyisocyanate, and an active hydrogen-containing (meth)acrylate. Part of the polyhydric alcohol is a diol having a straight chain of 3 to 7 carbon atoms and a side chain on the straight chain. The polyisocyanate includes at least one of hexamethylene diisocyanate, diphenylmethane diisocyanate, hydrogenated diphenylmethane diisocyanate, and tetramethylene diisocyanate.

### CROSS REFERENCE TO RELATED APPLICATIONS

This is a Continuation Application of PCT Application No. PCT/JP2009/056748, filed Mar. 31, 2009, which was published under PCT Article 21(2) in Japanese.

This application is based upon and claims the benefit of priority from prior Japanese Patent Application No. 2008-094386, filed Mar. 31, 2008, the entire contents of which are incorporated herein by reference.

### BACKGROUND OF THE INVENTION

1. Field of the Invention

The present invention relates to a urethane (meth)acrylate composition and a seal member usable in electronic devices and communication devices, specifically in hard disk devices.

2. Description of the Related Art

Urethane (meth)acrylate has been used for gaskets serving as seal members, because it can impart high flexibility to energy ray-curable resins. It is known that particles or outgas generated and emitted from gaskets cause a failure in electrical and electronic devices or communication devices, particularly, in hard disk devices. In recent years, as electrical and electronic devices and communication devices have been smaller, gaskets in such devices are required to have a narrower line width as well as a bulkiness. It is also known that if a composition for forming a bulky gasket has high viscosity, it will be difficult to extrude the composition from a coater, and therefore, such a composition should be a thixotropic material so that it can be easily extruded to form a bulky gasket. In general, a thixotropic agent is added to form a thixotropic composition.

Jpn. Pat. Appln. KOKAI Publication No. 2001-163931 proposes a photo-curable sealing composition which generates fewer outgas. However, such a composition contains a thixotropic agent such as silica fine powder so that it can form a bulky gasket. Such a thixotropic agent is not preferred to be used for precision electronic component such as hard disk device gaskets, because particles such as silica particles, outgas, or corrosive ions can be generated.

Japanese Patent No, 3560096 discloses unsaturated polyurethane made from hindered glycol and polycarboxylic acid containing polymerized fatty acid which is used to impart flexibility, water resistance or heat resistance. However, when such unsaturated polyurethane made from hindered glycol is used for gaskets, a thixotropic agent should be used to obtain a bulky gasket.

Jpn. Pat. Appln. KOKAI Publication No. 2003-7047 discloses a process that includes extruding gasket material from the outlet of a coater and simultaneously applying energy rays to the gasket material so that a bulky gasket can be formed. However, such a process needs a special coater, which will increase costs.

### BRIEF SUMMARY OF THE INVENTION

According to an aspect of the present invention, there is provided a urethane (meth)acrylate composition comprises:

a product of a reaction of a polyester polyol made from a polycarboxylic acid and a polyhydric alcohol; a polyisocyanate; and an active hydrogen-containing (meth)acrylate, wherein

part of the polyhydric alcohol is a diol having a straight chain of 3 to 7 carbon atoms and a side chain on the straight chain, and

the polyisocyanate comprises at least one of hexamethylene diisocyanate, diphenylmethane diisocyanate, hydrogenated diphenylmethane diisocyanate, and tetramethylene diisocyanate.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example where the seal member according to the present invention is used as a gasket; and

FIG. 2 is a diagram for determining the formability (the height/width ratio) of the seal member.

### DETAILED DESCRIPTION OF THE INVENTION

An object of the present invention, which has been made to solve the problems described above, is to provide a urethane (meth)acrylate composition that can keep bulky until before irradiated with energy rays, without any particular coating method or any thixotropic agent, and can achieve low hardness after cured with energy rays, and to provide a seal member comprising such a composition.

A urethane (meth)acrylate composition according to the present invention comprises a product of a reaction of a polyester polyol made from a polycarboxylic acid and a polyhydric alcohol; a polyisocyanate; and an active hydrogen-containing (meth)acrylate, wherein part of the polyhydric alcohol is a dial having a straight chain of 3 to 7 carbon atoms and a side chain on the straight chain, and the polyisocyanate comprises at least one of hexamethylene diisocyanate (HDI), diphenylmethane diisocyanate (MDI), hydrogenated diphenylmethane diisocyanate (H₁₂MDI), and tetramethylene diisocyanate (TMDI). Therefore, the polyisocyanate to be used may be one of HDI, MDI, H₁₂MDI, and TMDI, or a mixture of two or more of HDI, MDI, H₁₂MDI, and TMDI.

The seal member according to the present invention should have flexibility or water resistance, particularly when used in electrical and electronic devices or communication devices. Therefore, the seal member according to the present invention preferably comprises a molded product obtained by curing and molding the urethane (meth)acrylate composition in which the polycarboxylic acid is dimer acid, castor oil fatty acid or a fatty acid derived therefrom.

The present invention makes it possible to obtain a urethane (meth)acrylate composition that can keep bulky until before irradiated with energy rays, without any particular coating method or any thixotropic agent, and can achieve low hardness after cured with energy rays, and to obtain a seal member comprising such a composition.

The present invention is described in more detail below.

As used herein, the term “polycarboxylic acid” refers to a compound having two or more carboxyl groups per molecule, and examples of the polycarboxylic acid that may be used include aliphatic or aromatic dicarboxylic acids such as adipic acid, pimelic acid, suberic acid, azelaic acid, sebacic acid, maleic acid, fumaric acid, itaconic acid, phthalic acid, terephthalic acid, and isophthalic acid; and tricarboxylic acids such as trimellitic acid. Particularly for use in electrical and electronic devices or communication devices, dimer acid produced by intermolecular polymerization reaction of two or more unsaturated acid molecules from fatty acid such as tall oil fatty acid or soybean oil fatty acid; castor oil fatty acid; or fatty acid derived therefrom is preferably used as the polycarboxylic acid. In an embodiment of the present invention, two or more polycarboxylic acids may be used in combination.

A monocarboxylic acid may be used in combination with the polycarboxylic acid component, as long as the effects of the invention are not reduced. Examples of such a monocarboxylic acid include formic acid, acetic acid, propionic acid, decanoic acid, dodecanoic acid, tetradecanoic acid, heptadecanoic acid, octadecanoic acid, or monocarboxylic acids derived from animals and vegetables. The content of the monocarboxylic acid in all polycarboxylic acid components is preferably 30% by mole or less. If the monocarboxylic acid content is 30% by mole or more, the content of the (meth)acryloyl group at the molecular end may be low so that the resin may be insufficiently cured.

In an embodiment of the present invention, the polyhydric alcohol should satisfy a condition that “part of the polyhydric alcohol is a diol having a straight chain of 3 to 7 carbon atoms and a side chain on the straight chain,” as described above. The number of carbon atoms in the straight chain is limited to “3 to 7,” because if the number of carbon atoms in the straight-chain moiety of the diol is more than 7, the viscosity of the resin being synthesized may be so high that the resin may be difficult to be produced. It is well known that products obtained by curing a urethane (meth)acrylate produced with a polyester polyol made from a diol having a side chain on a straight chain have low hardness. Examples of “a diol having a straight chain of 3 to 7 carbon atoms and a side chain on the straight chain corresponding to part of the polyhydric alcohol” include 2-methyl-1,3-propanediol, 3-methyl-1,5-pentanediol, 2-methyl-1,5-pentanediol, 2-ethyl-1,5-pentanediol, 3-methyl-1,6-hexanediol, 2-methyl-1,4-butanediol, and 4-methyl-1,7-heptanediol. In particular, 2-methyl-1,3-propanediol and 3-methyl-1,5-pentanediol are highly thixotropic and therefore preferred.

In an embodiment of the present invention, a diol having a straight chain of 3 to 7 carbon atoms and a side chain on the straight chain may be used as the polyhydric alcohol. In an embodiment of the present invention, any other polyhydric alcohol may be used in combination with the dial, as long as the performance of the invention is not reduced. Examples of such a polyhydric alcohol include ethylene glycol, propylene glycol, 1,3-propanediol, 1,4-butanediol, 1,5-pentandiol, 1,6-hexanediol, neopentyl glycol, diethylene glycol, glycerin, sorbitol, and sucrose. These polyhydric alcohols may be used alone or in combination of two or more. The content of the diol having a straight chain of 3 to 7 carbon atoms and a side chain on the straight chain in all polyhydric alcohols is preferably 30% by mole or more, more preferably 50% by mole or more.

In an embodiment of the present invention, the polyisocyanate to be used may be HDI, MDI, H₁₂MDI, or TMDI, as described above. One of these polyisocyanates may be used alone, or two or more of these polyisocyanates may be used in combination. Modifications of these polyisocyanates may also be used. Any of the four polyisocyanates may also be used in combination with any other polyisocyanate than the four, such as tolylene diisocyanate, as long as the performance of the present invention is not reduced

In an embodiment of the present invention, examples of the active hydrogen-containing (meth)acrylate include 2-hydroxyethyl (meth)acrylate, 4-hydroxybutyl (meth)acrylate, 6-hydroxyhexyl (meth)acrylate, 2-hydroxybutyl (meth)acrylate, 3-hydroxybutyl (meth)acrylate, and 2-methyl-3-hydroxypropyl (meth)acrylate. These may be used alone or in combination of two or more.

In an embodiment of the present invention, a diluent having a polymerizable carbon-carbon unsaturated bond in the molecule may be used. Such a diluent may be monofunctional or polyfunctional. Examples of such a diluent include ethylene, propylene, styrene, N-vinyl-2-pyrrolidone, ethyl (meth)acrylate, butyl (meth)acrylate, 2-ethylhexyl (meth)acrylate, 2-hydroxylethyl (meth)acrylate, N-acryloyl morpholine, dicyclopentenyl (meth)acrylate, dicyclopentenyl oxy ethyl (meth)acrylate, isobornyl (meth)acrylate, phenoxyethyl (meth)acrylate, glycidyl (meth)acrylate, 1,4-butanediol di(meth)acrylate, 1,5-pentanediol di(meth)acrylate, 1,6-hexanediol di(meth)acrylate, 1,8-octanediol di(meth)acrylate, 1,9-nonanediol di(meth)acrylate, bis(acryloxyneopentyl glycol)adipate, dicyclopentenyl di(meth)acrylate, hydroxypivalate neopentylglycol di(meth)acrylate, triethylene glycol di(meth)acrylate, tripropylene glycol di(meth)acrylate, trimethylolpropane tri(meth)acrylate, trimethylolpropane ethylene oxide adduct tri(meth)acrylate, pentaerythritol tetra(meth)acrylate, and dipentaerythritol hexa(meth)acrylate.

If necessary, one of these diluents may be used, or two or more of these diluents may be used in combination. These diluents are preferably added in an amount of 5% to 80% by weight, more preferably 10% to 75% by weight, based on the total amount of the composition. If the diluent content is more than 80% by weight, viscosity of the energy ray-curable urethane (meth)acrylate composition may be reduced, so that the composition may have low thixotropy, which may make it impossible to form bulky products. If the diluent content is less than 5% by weight, the viscosity of the composition may be so high that it may be difficult to extrude the composition from a coater.

In an embodiment of the present invention, a known photopolymerization initiator may be used when the urethane (meth)acrylate composition is light-curable, particularly, ultraviolet-curable. Examples of such a photopolymerization initiator include an acetophenone type photopolymerization initiator such as diethoxyacetophenone, a benzoin type photopolymerization initiator such as benzoin or benzoin ethyl ether, a benzophenone type photopolymerization initiator such as benzophenone, and a thioxanthone type photopolymerization initiator such as thioxanthone or diethylthioxanthone. One of these photopolymerization initiators may be used alone, or two or more of these photopolymerization initiators may be used in combination. When the photopolymerization initiator is used, the amount of the photopolymerization initiator is preferably from 0.1 to 20 parts by weight, more preferably from 0.5 to 15 parts by weight, based on 100 parts by weight of all resin components. If the amount of the photopolymerization initiator is too large, the resulting gasket may produce organic volatile components during its use, which may foul the interior of the apparatus being used. If the amount is too small, the resin may be insufficiently cured.

In an embodiment of the present invention, if necessary, a photo sensitizer or a thermal polymerization inhibitor may also be used. According to an embodiment of the present invention, while thixotropic properties can be produced without using any thixotropic agent, a thixotropic agent may be used to increase the thixotropic properties. Examples of such a thixotropic agent include an inorganic filler such as silica fine power and an organic thickener such as hydrogenated castor oil.

In an embodiment of the present invention, the viscosity ratio between rotational viscometer readings at rotational speeds of 0.1 rpm and 1 rmp at 25° C. (thixotropic index, or TI value) is preferably 1.5 or more. If the TI value is less than 1.5, sufficient height cannot be achieved by molding.

In an embodiment of the present invention, the formability of the urethane (meth)acrylate composition is measured as described below. Specifically, first, a resin according to the present invention or comparative examples herein is charged into a general-purpose syringe with a diameter of 2 mm and then squeezed out of the syringe onto a metal plate 5 (SUS304) at a rate of about 200 cm/minute. The resin is then cured using a UV irradiation device to form a gasket 4, of which height h and width w are measured using vernier calipers and a thickness meter. The formability is shown in the h/w value (see FIG. 2).

### EXAMPLES

Some examples shown below are not intended to limit the scope of the present invention. In the description below, “parts” and “%” are all by mass.

First, polyester polyols to be used in the examples and the comparative examples are described in Synthesis Examples 1 to 10.

### Synthesis Example 1

### Synthesis of Polyester Polyol (I))

To a reaction vessel equipped with a stirrer and a water separator, 225 parts of 2-methyl-1,3-propanediol (2M-1,3PD), 1,000 parts of dimer acid (monomer acid 2%, dimer acid 78%, trimer acid 20%), 46 parts of lauric acid, and 0.02 parts of dibutyltin dilaurate as a catalyst were added. The mixture was subjected to a dehydration esterification reaction at about 240° C. under normal pressure with a nitrogen gas flow, while condensation water was drained, thereby a polyester polyol with an acid value of 0.24 mgKOH/g, a hydroxyl value of 55.2 mgKOH/g and a number average molecular weight of 2,033 was obtained.

### Synthesis Example 2

### Synthesis of Polyester Polyol (II)

To a reaction vessel equipped with a stirrer and a water separator, 300 parts of 3-methyl-1,5-pentanediol (3M-1,5PD), 1,000 parts of dimer acid (monomer acid 2%, dimer acid 78%, trimer acid 20%), 50 parts of lauric acid, and 0.02 parts of dibutyltin dilaurate as a catalyst were added. The same process as in Synthesis Example 1 was performed, thereby a polyester polyol with an acid value of 0.56 mgKOH/g, a hydroxyl value of 55.7 mgKOH/g and a number average molecular weight of 2,014.

### Synthesis Example 3

### Synthesis of Polyester Polyol (III)

To a reaction vessel equipped with a stirrer and a water separator, 114 parts of 2-methyl-1,3-propanediol, 147 parts of 3-methyl-1,5-pentanediol, 1,000 parts of dimer acid (monomer acid 2%, dimer acid 78%, trimer acid 20%), 50 parts of lauric acid, and 0.02 parts of dibutyltin dilaurate as a catalyst were added. The same process as in Synthesis Example 1 was then performed, thereby a polyester polyol with an acid value of 0.34 mgKOH/g, a hydroxyl value of 56.9 mgKOH/g and a number average molecular weight of 1,972 was obtained.

### Synthesis Example 4

### Synthesis of Polyester Polyol (IV)

To a reaction vessel equipped with a stirrer and a water separator, 111 parts of 2-methyl-1,3-propanediol, 129 parts of neopentyl glycol (NP), 1,000 parts of dimer acid (monomer acid 2%, dimer acid 78%, trimer acid 20%), 50 parts of lauric acid, and 0.02 parts of dibutyltin dilaurate as a catalyst were added. The same process as in Synthesis Example 1 was then performed, thereby a polyester polyol with an acid value of 0.4 mgKOH/g, a hydroxyl value of 56.1 mgKOH/g and a number average molecular weight of 2,000 was obtained.

### Synthesis Example 5

### Synthesis of Polyester Polyol (V)

To a reaction vessel equipped with a stirrer and a water separator, 51 parts of 2-methyl-1,3-propanediol, 1,000 parts of castor oil fatty acid, and 0.20 parts of dibutyltin dilaurate as a catalyst were added. The same process as in Synthesis Example 1 was then performed, thereby a polyester polyol with an acid value of 0.4 mgKOH/g, a hydroxyl value of 58.8 mgKOH/g and a number average molecular weight of 1,908 was obtained.

### Synthesis Example 6

### Synthesis of Polyester Polyol (VI)

To a reaction vessel equipped with a stirrer and a water separator, 686 parts of 2-methyl-1,3-propanediol, 1,000 parts of adipic acid, and 0.02 parts of dibutyltin dilaurate as a catalyst were added. The same process as in Synthesis Example 1 was then performed, thereby a polyester polyol with an acid value of 0.3 mgKOH/g, a hydroxyl value of 56.1 mgKOH/g and a number average molecular weight of 2,000 was obtained.

### Synthesis Example 7

### Synthesis of Polyester Polyol (VII)

To a reaction vessel equipped with a stirrer and a water separator, 645 parts of 2-methyl-1,3-propanediol, 468 parts of adipic acid, 532 parts of isophthalic acid, and 0.02 parts of dibutyltin dilaurate as a catalyst were added. The same process as in Synthesis Example 1 was then performed, thereby a polyester polyol with an acid value of 0.3 mgKOH/g, a hydroxyl value of 56.1 mgKOH/g and a number average molecular weight of 2,000 was obtained.

### Synthesis Example 8

### Synthesis of Polyester Polyol (VIII)

To a reaction vessel equipped with a stirrer and a water separator, 262 parts of neopentyl glycol, 1,000 parts of dimer acid (monomer acid 2%, dimer acid 78%, trimer acid 20%), 50 parts of lauric acid, and 0.02 parts of dibutyltin dilaurate as a catalyst were added. The same process as in Synthesis Example 1 was then performed, thereby a polyester polyol with an acid value of 0.32 mgKOH/g, a hydroxyl value of 54.7 mgKOH/g and a number average molecular weight of 2,051 was obtained.

### Synthesis Example 9

### Synthesis of Polyester Polyol (IX)

To a reaction vessel equipped with a stirrer and a water separator, 191 parts of propylene glycol (PG), 1,000 parts of dimer acid (monomer acid 2%, dimer acid 78%, trimer acid 20%), 50 parts of lauric acid, and 0.02 parts of dibutyltin dilaurate as a catalyst were added. The same process as in Synthesis Example 1 was then performed, thereby a polyester polyol with an acid value of 0.1 mgKOH/g, a hydroxyl value of 53.9 mgKOH/g and a number average molecular weight of 2,081 was obtained.

### Synthesis Example 10

### Synthesis of Polyester Polyol (X)

To a reaction vessel equipped with a stirrer and a water separator, 408 of 2-butyl-2-ethylpropanediol (2-Bu-2Et-1,3PD), 1,000 parts of dimer acid (monomer acid 2%, dimer acid 78%, trimer acid 20%), 50 parts of lauric acid, and 0.03 parts of dibutyltin dilaurate as a catalyst were added. The same process as in Synthesis Example 1 was then performed, thereby a polyester polyol with an acid value of 0.44 mgKOH/g, a hydroxyl value of 54.4 mgKOH/g and a number average molecular weight of 2,063 was obtained.

Next, specific examples and comparative examples are described below.

### Example 1

### Synthesis of Urethane Acrylate Resin (I)

To a reaction vessel equipped with a stirrer and an air-cooled condenser, 500 parts of polyester polyol (I) obtained in Synthesis Example 1, 62 parts of hexamethylene diisocyanate (HDI), 592 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 29 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (I) was obtained.

### Example 2

### Synthesis of Urethane Acrylate Resin (II)

To a reaction vessel equipped with a stirrer and an air-cooled condenser 500 parts of polyester polyol (II) obtained in Synthesis Example 2, 63 parts of hexamethylene diisocyanate, 148 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 29 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added to and the mixture was stirred for 1 hour, the desired urethane acrylate resin (II) was obtained.

### Example 3

### Synthesis of Urethane Acrylate Resin (III)

To a reaction vessel equipped with a stirrer and an cooled condenser, 500 parts of polyester polyol (III) obtained in Synthesis Example 3, 64 parts of hexamethylene diisocyanate, 594 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 29 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (III) was obtained.

### Example 4

### Synthesis of Urethane Acrylate Resin (IV)

To a reaction vessel equipped with a stirrer and an air-cooled condenser 500 parts of polyester polyol (IV) obtained in Synthesis Example 4, 62 parts of hexamethylene diisocyanate, 165 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 28 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (IV) was obtained.

### Example 5

### Synthesis of Urethane Acrylate Resin (V)

To a reaction vessel equipped with a stirrer and an air-cooled condenser, 500 parts of polyester polyol (V) obtained in Synthesis Example 5, 66 parts of hexamethylene diisocyanate, 244 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 30 parts of 2-hydroxyethyl acrylate, 0.60 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (V) was obtained.

### Example 6

### Synthesis of Urethane Acrylate Resin (VI)

To a reaction vessel equipped with a stirrer and an air-cooled condenser, 500 parts of polyester polyol (VI) obtained in Synthesis Example 6, 53 parts of hexamethylene diisocyanate, 285 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 15 parts of 2-hydroxyethyl acrylate, 0.6 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (VI) was obtained.

### Example 7

### Synthesis of Urethane Acrylate Resin (VII)

To a reaction vessel equipped with a stirrer and an air-cooled condenser, 500 parts of polyester polyol (VII) obtained in Synthesis Example 7, 62 parts of hexamethylene diisocyanate, 156 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 28 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (VII) was obtained.

### Example 8

### Synthesis of Urethane Acrylate Resin (VIII)

To a reaction vessel equipped with a stirrer and an air-cooled condenser 500 parts of polyester polyol (I) obtained in Synthesis Example 1, 95 parts of hydrogenated diphenylmethane diisocyanate (H₁₂MDI), 198 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 29 parts of 2-hydroxyethyl acrylate, 0.62 parts of hydroquinone monomethyl ether, and 0.25 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (VIII) was obtained.

### Example 9

### Synthesis of Urethane Acrylate Resin (IX)

To a reaction vessel equipped with a stirrer and an air-cooled condenser, 500 parts of polyester polyol (I) obtained in Synthesis Example 1, 43.4 parts of hexamethylene diisocyanate, 19.3 parts of tolylene diisocyanate (TDI), 592 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 29 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (IX) was obtained.

### Comparative Example 1

### Synthesis of Urethane Acrylate Resin (X)

To a reaction vessel equipped with a stirrer and an air-cooled condenser, 500 parts of polyester polyol (VIII) obtained in Synthesis Example 8, 61 parts of hexamethylene diisocyanate, 104 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 28 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (X) was obtained.

### Comparative Example 2

### Synthesis of Urethane Acrylate Resin (XI)

To a reaction vessel equipped with a stirrer and an air-cooled condenser, 500 parts of polyester polyol (IX) obtained in Synthesis Example 9, 61 parts of hexamethylene diisocyanate, 241 parts of dicyclopentadieneoxyethyl acrylate, 0.5 parts of IRGANOX 1010 (trade name, manufactured by Ciba Specialty Chemicals Inc), and 0.06 parts of dibutyltin dilaurate as a catalyst were added. The mixture was heated with stirring and allowed to react at 80° C. for 5 hours. Then, 28 parts of 2-hydroxyethyl acrylate, 0.59 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (XI) was obtained.

### Comparative Example 3

### Synthesis of Urethane Acrylate Resin (XII)

To a reaction vessel equipped with a stirrer and an air-cooled condenser, 500 parts of polyester polyol (X) obtained in Synthesis Example 10, 61 parts of hexamethylene diisocyanate, 241 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 28 parts of 2-hydroxyethyl acrylate, 0.59 parts of hydroquinone monoethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (XII) was obtained.

### Comparative Example 4

### Synthesis of Urethane Acrylate Resin (XIII)

To a reaction vessel equipped with a stirrer and an air-cooled condenser, 500 parts of polyester polyol (I) obtained in Synthesis Example 1, 82 parts of isophorone diisocyanate (IPDI), 193 parts of dicyclopentadieneoxyethyl acrylate, 0.5 parts of IRGANOX 1010 (trade name, manufactured by Ciba Specialty Chemicals Inc.), and 0.06 parts of dibutyltin dilaurate as a catalyst were added. The mixture was heated with stirring and allowed to react at 80° C. for 5 hours. Then, 29 parts of 2-hydroxyethyl acrylate, 0.61 parts of hydroquinone monomethyl ether, and 0.24 parts of dibutyltin dilaurate as a catalyst were added thereto. The temperature of the mixture was held for 2 hours, and it was confirmed by infrared absorption spectrometry that the isocyanate group absorption was absent. A photopolymerization initiator (3% of IRGACURE 184 [trade name, manufactured by Ciba Specialty Chemicals Inc.] and 1% of IRGACURE 819 [trade name, manufactured by the same company]) was then added thereto and the mixture was stirred for 1 hour, thereby the desired urethane acrylate resin (XIII) was obtained.

The viscosity (at rotational speeds of 0.1 rpm and 1 rpm), TI value (0.1/1) and formability (h/w) of the urethane acrylate resins of Examples 1 to 9 and Comparative Examples 1 to 4 were determined, and the results shown in Tables 1 and 2 below were obtained. The TI value indicates a thixotropic index. The TI value (0.1/1) is a value obtained by dividing the viscosity measured at a rotational speed of 0.1 rpm with a rheometer/viscometer at 25° C. by the viscosity measured at a rotational speed of 1 rpm with the same meter at 25° C. The viscometer used was Rheometer RFS-3 (trade name) manufactured by Rheometrics, Inc. The measurement was performed using a parallel plate (25 mm in diameter) and a gap of 1.5 mm.

TABLE 1

| | Example 1 | Example 2 | Example 3 | Example 4 | Example 5 | Example 6 | Example 7 |
|---|---|---|---|---|---|---|---|
| Polyhydric alcohol | 2M-1, 3PD | 3M-1, 5PD | 2M-1, 3P, D/ | 2M-1, 3PD/ | 2M-1, 3PD | 2M-1, 3PD | 2M-1, 3PD |
| | | | 3M-1, 5PD (5:5) | NP (5:5) | | | |
| Carboxylic acid | Dimer acid | Dimer acid | Dimer acid | Dimer acid | Castor oil | Adipic acid | Adipic acid |
| | | | | | fatty acid | | Isophthalic acid |
| Polyisocyanate | HDI | HDI | HDI | HDI | HDI | HDI | HDI |
| Viscosity (0.1 rpm) | 2,080,000 | 295,000 | 612,000 | 581,000 | 813,000 | 604,000 | 520,000 |
| Viscosity (1 rpm) | 229,000 | 142,000 | 72,000 | 65,000 | 73,000 | 215,000 | 160,000 |
| TI value (0.1/1) | 9.1 | 2.1 | 8.5 | 8.9 | 11.1 | 2.8 | 3.3 |
| Formability (h/w) | 0.98 | 0.54 | 0.56 | 0.78 | 0.86 | 0.60 | 0.63 |

In Table 1, the unit of the viscosity is mPa · s.

TABLE 2

| | | | Comparative | Comparative | Comparative | Comparative |
|---|---|---|---|---|---|---|
| | Example 8 | Example 9 | Example 1 | Example 2 | Example 3 | Example 4 |
| Polyhydric alcohol | 2M-1, 3PD | 2M-1, 3PD | NP | PG | 2Bu—2Et-1, 3PD | 2M-1, 3PD |
| Carboxylic acid | Dimer acid | Dimer acid | Dimer acid | Dimer acid | Dimer acid | Dimer acid |
| Polyisocyanate | H₁₂MDI | HDI/TDI (=7/3) | HDI | HDI | HDI | IPDI |
| Viscosity (0.1 rpm) | 128,000 | 1,400,000 | 219,000 | 23,000 | 26,000 | 38,000 |
| Viscosity (1 rpm) | 77,000 | 192,000 | 211,000 | 22,000 | 26,000 | 39,000 |
| TI value (0.1/1) | 1.7 | 7.3 | 1.0 | 1.0 | 1.0 | 1.0 |
| Formability (h/w) | 0.68 | 0.9 | 0.42 | 0.34 | 0.4 | 0.36 |

In Table 2, the unit of the viscosity is mPa · s.

Tables 1 and 2 show at Examples 1 to 9 all exhibit a TI value (0.1/1) of 1.5 or more and therefore develop thixotropy. It is also shown that, in contrast, Comparative Examples 1 to 4 all exhibit a TI value of 1.0 and therefore no thixotropy. It is also apparent that the formability (h/w) of Examples 1 to 9 is about twice to three times higher than that of Comparative Examples 1 to 4 and therefore Examples 1 to 9 have good formability. It has been found that when the viscosity at a rotational speed of 0.1 rpm at 25° C. is not more than 100,000 mPa·s, such as that of Comparative Example 2, 3 and 4, a bulky product cannot be achieved by application with a dispenser.

As described above, the urethane (meth)acrylate composition of each of the above examples according to the present invention comprises a polyester polyol made from a polycarboxylic acid and a polyhydric alcohol, a polyisocyanate, and an active hydrogen-containing (meth)acrylate, wherein part of the polyhydric alcohol is a diol having a straight chain of 3 to 7 carbon atoms and a side chain on the straight chain, and the polyisocyanate comprises HDI or H₁₂MDI. Therefore, the resulting urethane (meth)acrylate composition of each of the above examples can keep bulky until before irradiated with energy rays, without using any particular coating method or any thixotropic agent, in contrast to conventional techniques, and can achieve low hardness after cured with energy rays. When the composition used in the production of a seal member contains dimes acid or castor oil fatty acid as the carboxylic acid, the resulting seal member has a high level of flexibility, water resistance or heat resistance. In addition, when the content of the dimer component in the dimer acid is higher in the composition used, the resulting seal member has higher strength.

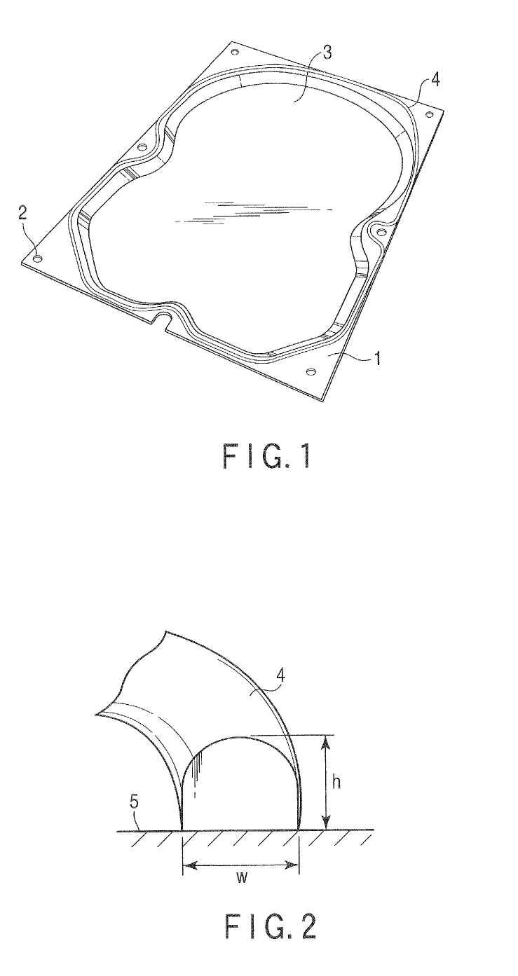

In an embodiment of the present invention, for example, a gasket serving as a seal member as shown in FIG. 1, for example, may be formed using a resin composition discharging apparatus. In the drawing, for example, reference numeral 1 represents a metallic cover plate to be attached to the cover side of the main body of an electronic device. The cover plate 1 has screw holes 2 which are used for attaching the cover plate 1 to the main body of the electronic device. The central part 3 of the cover plate 1 is dented, and a gasket 4 is placed in the form of a ring on the narrow portion around the central part 3. In this state, the cover plate 1 is attached to the main body of the electronic device and fixed with screws.

The examples described above are not intended to limit the scope of the present invention, and in the embodiment and practice of the invention, the elements may be modified without departing from the gist of the invention. More specifically, while a gasket as a seal member has been described in the examples, the examples may also be used in other applications. In addition, any combinations of different elements described in the examples may be used to form a variety of products according to the present invention. For example, some of the elements shown in the examples may be omitted, or some elements of different examples may be combined as appropriate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A urethane (meth)acrylate composition, comprising a product of a reaction of a polyester polyol made from a polycarboxylic acid and a polyhydric alcohol; a polyisocyanate; and an active hydrogen-containing (meth)acrylate, wherein
part of the polyhydric alcohol is a diol having a straight chain of 3 to 7 carbon atoms and a side chain on the straight chain, and
the polyisocyanate comprises at least one of hexamethylene diisocyanate, diphenylmethane diisocyanate, hydrogenated diphenylmethane diisocyanate, and tetramethylene diisocyanate.

2. The urethane (meth)acrylate composition according to claim 1, further comprising a diluent having a polymerizable carbon-carbon unsaturated bond in its molecule.

3. The urethane (meth)acrylate composition according to claim 1, which has a viscosity ratio (thixotropic index) of 1.5 or more, wherein the viscosity ratio is a ratio between rotational viscometer readings at rotational speeds of 0.1 rpm and 1 rmp at 25° C.

4. The urethane (meth)acrylate composition according to claim 1, wherein the polycarboxylic acid is dimer acid, castor oil fatty acid or a fatty acid derived therefrom.

5. A seal member, comprising a molded product obtained by curing and molding the urethane (math) acrylate composition according to claim 1.

6. A seal member for an electrical and electronic device or a communication device, comprising a molded product obtained by curing and molding the urethane (meth)acrylate composition according to claim 4.
